(19) United States
(12) Patent Application Publication
(10) Pub. No.: US 2012/0056341 A1
(43) Pub. Date: Mar. 8, 2012

(54) SILICA NANOCAPSULES FROM NANO-EMULSIONS OBTAINED BY PHASE INVERSION

(75) Inventors: Shlomo Magdassi, Jerusalem (IL); David Avnir, Jerusalem (IL); Liat Spernath, Kfar-Saba (IL)

(73) Assignee: YISSUM RESEARCH DEVELOPMENT COMPANY OF THE HEBREW UNIVERSITY OF JERUSALEM, LTD., Jerusalem (IL)

(21) Appl. No.: 13/256,040

(22) PCT Filed: Mar. 9, 2010
(86) PCT No.: PCT/IL2010/000191

§ 371 Date: Nov. 23, 2011

Related U.S. Application Data
(60) Provisional application No. 61/159,548, filed on Mar. 12, 2009.

(51) Int. Cl. A61J 3/07

(52) U.S. Cl. 264/4

(57) ABSTRACT

Silica nanocapsules are prepared from a nanoemulsions obtained by a phase inversion method.

### FIELD OF THE INVENTION

This invention relates to silica nanocapsules prepared from nanoemulsions obtained by the phase inversion temperature method.

### BACKGROUND OF THE INVENTION

Nanocapsules are submicroscopic colloidal systems, composed of solid or liquid core surrounded by a thin polymer membrane [1]. Such core-shell systems may be prepared from micro- or nanoemulsions via a polymerization reaction at the interface of the droplets, the so-called interfacial polymerization reaction.

Interfacial polymerization, or interfacial polycondensation occurs at the interface of two immiscible phases such as water and oil, and a polymer membrane is produced. Each phase contains one of the monomers participating in the reaction to form the polymer membrane. In a typical method for constructing core-shell nanocapsules via interfacial polymerization, an emulsion or microemulsion is first prepared, either oil-in-water (O/W), which leads to nanocapsules with an oily core suspended in water, or water-in-oil (W/O), which leads to nanocapsules with an aqueous core suspended in oil [2].

Silica nanocapsules can be obtained, in a similar manner, by hydrolysis and polycondensation of inorganic silicates or alcoxysilanes, so called the sol-gel processes, at the interface of these droplets as templates [3-7]. Silica micro- and nanoparticles have also been prepared by Esquena et al. [8-9] by hydrolysis and condensation reactions of tetraethoxysilane in W/O emulsions prepared by physicochemical low energy emulsification methods (PIT) and emulsification by the addition of oil to an aqueous solution containing a surfactant (catastrophic inversion). Silica particles, having mean sizes of 0.5-1000 μm, have been obtained using these methods.

Micro- and nanocapsules (organic or inorganic) are widely used in areas such as pharmaceutical and medical industries (e.g. for drug delivery system) [4, 5, 10] food, personal care and cosmetics [11] and agriculture [12, 13].

### REFERENCES

[1] P. Couvreur, G. Barratt, E. Fattal, P. Legrand, C. Vauthier, “Nanocapsule Technology: A Review”, Critical Reviews in Therapeutic Drug Carrier Systems, 19 (2002) 99-134.

[2] M. Takasu, H. Kawaguchi, “Preparation of colored latex with polyurea shell by miniemulsion polymerization”, Colloid Polym. Sci., 283 (2005) 805-811.

[3] B. Peng, M. Chen, S. Zhou, L. Wu, X. Ma, “Fabrication of hollow silica spheres using droplet templates derived from miniemulsion technique”, Journal of Colloid and Interface Science, 321 (2008) 67-73.

[4] R. S. Underhill, A. V. Jovanovic, S. R. Carino, M. Varshney, D. O. Shah, D. M. Dennis, T. E. Morey, R. S. Duran, “Oil-filled silica nanocapsules for lipophilic drug uptake: Implications for drug detoxification therapy”, Chemistry of Materials, 14 (2002) 4919-4925.

[5] A. V. Jovanovic, R. S. Underhill, T. L. Bucholz, R. S. Duran, “Oil Core and Silica Shell Nanocapsules: Towards Controlling the Size and the Ability To Sequester Hydrophobic Compounds”, Chem. Mater., 17 (2005) 3375-3383.

[6] Y. A. Bok, S. Sang II, In Chan Band Suk-In H, “Core/shell silica-based in-situ microencapsulation: A self-templating method”, Chem. Commun., (2006) 189-190.

[7] K. S. Finnie, J. R. Bartlett, C. J. A. Barbe, L. Kong, “Formation of Silica Nanoparticles in Microemulsions”, Langmuir, 23 (2007) 3017-3024.

[8] Esquena J, Pons R, Azemar N, Caelles J, Solaris C., “Preparation of monodisperse silica particles in emulsion media”, Colloid Surf A 123-124 (1997) 575-586.

[9] J. Esquena, C. Solans, “Phase changes during silica particle formation in water-in-oil emulsions”, Colloid Surf A 183-185 (2001) 533-540.

[10] M. Fujiwara, K. Shiokawa, K. Hayashi, K. Morigaki, Y. Nakahara, “Direct encapsulation of BSA and DNA into silica microcapsules (hollow spheres)”, Journal of Biomedical Materials Research Part A, 81A (2007) 103-112.

[11] U.S. Pat. No. 7,211,273.

[12] A. Wyss, N. Cordente, U. von Stockar, I. W. Marison, “A Novel Approach for the Extraction of Herbicides and Pesticides From Water Using Liquid-Core Microcapsules”, Biotechnology and Bioengineering, 87 (2004) 734-742.

[13] T. Takahashi, Y. Taguchi, M. Tanka, “Preparation of Polyurea Microcapsules Containing Pyrethroid Insecticide with Hexamethylene Diisocyanate Uretidione and Isocyanurate”, Journal of Chemical Engineering of Japan, 38 (2005) 929-936.

[14] T. Tadros, P. Izuierdo, J. Esquena, C. Solans, “Formation and stability of nano-emulsions”, Adv. Colloid Interface Sci., 108-109 (2004) 303-318.

[15] K. Shinoda, “The correlation between the dissolution state of nonionic surfactant and the type of dispersion stabilized with the surfactant”, J. Colloid Interface Sci., 24 (1967) 4-9.

[16] K. Shinoda, H. Saito, “The effect of temperature on the phase equilibria and the types of dispersions of the ternary system composed of water, cyclohexane, and nonionic surfactant”, J. Colloid Interface Sci., 26 (1968) 70-74.

[17] P. Izquierdo, J. Esquena, Th. F. Tadros, C. Federen, M. J. Garcia, N. Azemar, C. Solans, “Formation and stability of nano-emulsions prepared using the phase Inversion temperature method”, Langmuir 18 (2002) 26-30.

[18] T. Forster, W. Von Rybinski, A. Wadle, “Influence of microemulsion phases on the preparation of fine-disperse emulsions”, Adv. Colloid Interface Sci., 58 (1995) 119-149.

[19] T. Forster, F. Schambil, W. Von Rybinski, “Production of fine disperse and long-term stable oil-in-water emulsions by the phase inversion temperature method”, J. Dispersion Sci. Technol., 13 (1992) 183-193.

[20] WO 2005/102507

[21] G. Nizri, S. Lagerge, A. Kamyshny, D. T Major, S. Magdassi, “Polymer surfactant interactions: Binding mechanism of sodium dodecyl sulfate to poly (diallyldimethyl ammonium chloride)”, Journal of Colloid and Interface Science, 320 (2008) 74-81.

[22] N. Anton., G. Pascal, B. Jean-Pierre, S. Patrick, “Nano-emulsions and nanocapsules by the PIT method: An investigation on the role of the temperature cycling on the emulsion phase inversion”, International Journal of Pharmaceutics, 344 (2007) 44-52.

[23] H. Kunieda, K. Shinoda, “Evaluation of the hydrophilelipophile balance (HLB) of nonionic surfactants I. Multisurfactant systems”, J. Colloid Interface Sci., 107 (1985) 107-121.

[24] M. A. Modragón, V. M. Castano, M. J. Garcia, S. C. A. T\check{e}llez, “Vibrational analysis of Si(OC₂H₅)₄ and spectroscopic studies on the formation of glasses via silica gels”, Vibrational Spectroscopy, 9 (1995) 293-304.

[25] C. Chia-Lu, H. Scott Fogler, “Kinetics of Silica Particle Formation in Nonionic W/O Microemulsions from TEOS”, AIChE Journal, 42 (1996) 3153-3163.

### SUMMARY OF THE INVENTION

Nanoemulsions, also referred to as mini-emulsions, ultrafine emulsions and submicrometer emulsions, are a class of transparent, translucent, or sometimes ‘milky’ emulsion systems, having oil droplets ranging in size from 40 to 300 nm. Unlike microemulsions, which are transparent and thermodynamically stable, nanoemulsions are only kinetically stable. However, the long-term physical stability of nanoemulsions is excellent as compared to microemulsions. The main advantage of using nanoemulsions over microemulsions, for industrial applications, is that microemulsions require high surfactant concentration for their preparation. Nanoemulsions, on the contrary, may be prepared using moderate surfactant concentrations (in the range of 4-8 wt %) [14]. Preparation of nanoemulsions, however, requires a high input of mechanical energy, which is achieved by equipments such as high pressure homogenizers or by applying high levels of ultrasound energy.

The present invention provides a process for the preparation of silica nanocapsules from nanoemulsions, said nanoemulsions being obtained by the phase inversion temperature (PIT) method, introduced by Shinoda and co-workers [15, 16]. The PIT concept is based on a temperature-induced phase inversion of emulsions, stabilized by surfactants, e.g., nonionic surfactants, containing ethoxylated groups, involving the inversion of oil-in-water system, O/W, to water-in-oil system, W/O, upon heating. It was found that if these emulsions are heated to their phase inversion temperature and than rapidly cooled, very small and uniform oil droplets are obtained, constituting the O/W nanoemulsion. The PIT technique makes use of the temperature sensitivity of nonionic surfactants containing ethoxylated groups, undergoing dehydration during heating into a more hydrophobic form, thus favoring the formation of a W/O emulsion [17-19].

While the preparation of nanoparticles having hydrophobic core and acrylate or methacrylate shells from nanoemulsions manufactured by the phase inversion technique has been reported [20], the preparation of inorganic nanocapsules, particularly of silica, by the phase inversion technique has not been reported.

Thus, in its most general aspect, the present invention provides a process for the manufacture of one or more (a plurality) silica nanocapsules from a nanoemulsion having been prepared by physiochemical low energy emulsification method, which does not require the use of e.g., high pressure homogenizers. The nanoemulsions have been prepared from a dispersion of a hydrophobic liquid and a silica precursor, as the oil phase, and water, as the aqueous phase, in the presence of at least one surfactant, as exemplified.

In one aspect, the present invention provides a process for the manufacture of silica nanocapsules, said process comprising:
obtaining a nanoemulsion of at least one hydrophobic material, at least one silica precursor and at least one surfactant, the nanoemulsion being formed under conditions of emulsion inversion; and
inducing interfacial polymerization of silica around droplets of said at least one hydrophobic material;

thereby obtaining nanocapsules having silica shell and hydrophobic core.

The nanoemulsion employed in the process of the invention, for the preparation of silica microcapsules, is a low-energy O/W nanoemulsion prepared by first forming an emulsion of the at least one hydrophobic material, at least one silica precursor, in water (in the presence or absence of salt, e.g., sodium chloride), in the presence of at least one surfactant. The emulsion, prepared by any dispersing method, e.g., stirring, as known in the art, is then conditioned to form a nanoemulsion by an inversion method.

According to the present invention, the nanoemulsion is formed by first heating the emulsion above its phase inversion temperature (herein referred to as the “PIT temperature”), forming a W/O emulsion, which is then cooled below the PIT temperature forming a nanoemulsion of oil droplets in water. Interfacial polymerization of the silica precursor may then be induced to obtain the nanocapsules. The heating-cooling process may be repeated several times, prior to the polymerization step, in order to obtain a more efficient nanoemulsion.

The PIT temperature of any emulsion employed is, in fact, the temperature at which the interfacial tension between the oil and the water phases is at a minimum, namely where the affinity of the at least one surfactant for each of the phases is substantially identical. The outcome of such an intercation is the formation of a bicontinuous phase consisting of an oil phase and a water phase regions, each of said regions being separated by surfactant molecules.

The PIT temperature is unique to each system employed and may vary based on one or more of the following: (i) the selection of components constituting the initial emulsion, (ii) the relative concentration of each component in the emulsion, (iii) the nature of the surfactant used, and (iv) the specific surfactant concentration. Notwithstanding, the PIT temperature may easily be determined by a variety of techniques know in the art such as rheology and microcalorimetry.

The PIT temperature may also be determined by observing microscopially a sample of the emulsion produced in the initial stage, prior to heating, and monitoring the observed changes as the temperature rises and passes through the PIT temperature; the formation of the W/O emulsion is easily noted.

The PIT temperature may also be determined by measuring the conductivity of the emulsion during the heating process. At a temperature below the PIT, the conductivity of the aqueous phase increases with heating until it reaches the PIT temperature, at which temperature the conductivity drops to zero. At this temperature, the oil phase becomes the continuous phase and the emulsion is inverted. In accordance with the present invention, the PIT is taken as the average value of the temperature at which the conductivity is the highest and the lowest. As known in the art, the conductivity may be measured using any conductivity-temperature meter.

Above the PIT temperature, the resulting W/O emulsion is cooled and the system collapses into a nanoemulsion. The W/O emulsion may be allowed to cool or is actively cooled to any temperature below the PIT temperature at which a nanoemulsion is formed. In some embodiments, the temperature is lowered to room temperature (23-27° C.). In other embodiments, the temperature is lowered to below room temperature. In still other embodiments, the temperature is lowered to 0° C. or to a sub-zero temperature.

Typically, the temperature is lowered rapidally to a temperature below the PIT temperature and maintained at such a temperature over time. The cooling of the W/O emulsion may be by means of an external cooling such as a cold-water bath or an ice bath or by introding into the emulsion a material capable of reducing its temperature, such as ice water. The cooling period may be 1 to 30-minute long.

As stated above, the nanoemulsion is derived from an emulsion of an oil phase, being composed of at least one hydrophobic material and a silica precursor, and an aqueous phase, in the presence of at least one surfactant. In the nanoemulsion, the average size of the dispersed oil phase is at most 1 micron. In some embodiments, the average size of the dispersed is selected from 10 to 500 nm, 20 to 100 nm and 20 to 50 nm.

In other embodiments, the nanoemulsion comprises an oil phase in the form of droplets, each droplet having a mean particle size of at most 1 micron, or between about 0.1 to 1 microns. In some embodiments, the particle size of said droplet is 100-500 nm in diameter. In other embodiments, the diameter is between about 10 and 100 nm.

The at least one hydrophobic material may be in the form of a liquid material, which may be a pure hydrophobic liquid or a mixture of such liquids. In some embodiments, the at least one hydrophobic material is a liquid solution composed of a liquid carrier, such as an organic hydrophobic or hydrophilic liquid, solubilizing at least one hydrophobic material, which may be a solid or a liquid at ambient (23-27° C.).

The hydrophobic material is generally selected amongst materials which are substantially insoluble in water, namely having a solubility of less than about 1 gram per 100 mL of distilled water at ambient temperature or a solubility of less than about 0.5 grams per 100 mL, or a solubility of less than about 0.05 grams per 100 mL of distilled water.

In some embodiments, said at least one hydrophobic material is selected from a wax, e.g., a fatty alcohol, a fatty acid, naturally occurring waxes; and an oil, e.g., a hydrocarbon, a silicone oil, a mineral oil, a fluorocarbon oil, an organic solvent, an animal oil, a vegetable oil, a natural oil, a synthetic oil, a semi-synthetic oil.

In some embodiments, the oil phase is or comprises retinol or a derivative thereof, e.g., an ester such as retinyl palmitate.

In some embodiments, said at least one hydrophobic martial is a wax, being selected, in a non-limiting manner, from isostearic acid, oleic acid, oleyl alcohol, stearic acid, cetyl alcohol, stearyl alcohol, erucic acid, linoleic acid, arachidonic acid, linolenic acid, lauric acid, myristic acid, palmitic acid, stearic acid, behenic acid, oleic acid, 12-hydroxystearic acid, undecylenic acid, linolenic acid, eicosapentaenoic acid (EPA), docosahexaenoic acid (DHA), an animal wax, spermaceti, lanolin (wool wax), insect wax, beeswax, chinese wax, a vegetable wax, candelilla wax, castor wax, a petroleum wax, a paraffin wax, a polyethylene wax and a mineral wax.

In some embodiments, said at least one hydrophobic material is an oil, being selected, in a non-limiting manner, from hydrocarbon oils of hydrocarbons having between 6 and 22 carbon atoms. In some embodiments, said hydrocarbon has between 6 and 15 carbon atoms, between 6 and 12 carbon atoms, between 6 and 10 carbon atoms or between 8 and 10 carbon atoms. In some embodiments, said oil is decane.

In other embodiments, said oil is a natural oil (or natural mixture commonly referred to as an oil), selected from soybean oil, avocado oil, squalene oil, olive oil, canola oil, corn oil, rapeseed oil, safflower oil, sunflower oil, fish oil, cinnamon bark oil, coconut oil, cottonseed oil, flaxseed oil and pine needle oil.

In other embodiments, said hydrophobic material is a drug, a bioactive, a cosmetic material, a flavoring agent, a coloring agent, an antioxidant and any other such material.

The drug or biactive may be a biomolecule selected from a hormone, a hormone analogue, an enzyme, an enzyme inhibitor, a signal transduction protein or a fragment thereof, an antibodie or fragment thereof, a single-chain antibodie, a binding protein, a binding domain, a peptide, an antigen, an adhesion protein, a structural protein, a regulatory protein, a toxin protein, a cytokine, a transcription regulatory factor, a blood coagulation factor, a plant defense-inducing protein and others. In some embodiments, the hydrophobic material is retinol or a derivative thereof, e.g., an ester such as retinyl palmitate.

The hydrophobic material may be a hydrophobic material solubilized in at least one liquid carrier, e.g., an organic liquid, which may or may not be hydrophobic. Non-limiting examples of such organic liquid carriers are alcohols, such as methanol, ethanol, isopropyl alcohol, glycerol, n-butanol, butylene glycol, propylene glycols, sorbitol; halogenated solvents, such as chloroform, dichloromethane; hydrocarbons, such as hexane, cyclohexane; polar solvents, such as DMSO, DMF; phosphates, such as dialkyl phosphate, tri-alkyl phosphate, e.g., tri-n-butyl phosphate; ethers, such as diethyl ether, THF; esters, such as ethyl acetate; ketones, such as acetone; organic acids, such as acetic acid, formic acid; and others.

In some embodiments, the oil phase constitutes at least 10% w/w of the total weight of the initial emulsion. In other embodiments, the oil phase constitutes at most 40% w/w of the total weight of the initial emulsion. In further embodiments, the oil phase constitutes between about 10 and 30% w/w of the total weight of the emulsion. In additional embodiments, the oil phase constitutes 10, 15, 20, 25, or 30% w/w of the total weight of the emulsion.

The oil phase may be comprised of one or more water-insoluble materials, one of which being the hydrophobic material, as defined, and the other being said at least one silica precursor. The oil phase may comprise one or more additional water-insoluble materials as a carrier or a material to be encapsulated according to the present invention. In some embodiments, the oil phase comprises at least one silica precursor solubilized in at least one hydrophobic material, e.g., an organic solvent, where the at least one silica precursor constitutes between about 5 to 75% of the total weight of the oil phase.

The at least one silica precursor is at least one water-insoluble organosilane. In some embodiments, said at least one organosilane is selected from phenyltrimethoxysilane; phenyltriethoxysilane; diphenyldimethoxysilane; diphenyl diethoxysilane; 3-aminopropyltrimethoxysilane; 3-aminopropyltriethoxysilane; N-(3-trimethoxysilylpropyl)pyrrole; N-[3-(triethoxysilyl)propyl]-4,5-dihydroimidazole; beta-trimethoxysilylethyl-2-pyridine; N-phenylaminopropyltrimethoxysilane; 3-(N-styryl methyl-2-aminoethylamino)propyltrimethoxysilane; methacryloxy-propenyltrimethoxy silane; 3-methacryloxypropyltrimethoxysilane; 3-methacryloxypropyltris (methoxyethoxy)silane; 3-cyclopentadienylpropyltriethoxysilane; 7-oct-1-enyltri methoxysilane, 3-glycidoxypropyltrimethoxysilane; γ-glycidoxypropylmethyl dimethoxysilane; γ-glycidoxypropylpylpentamethyldisiloxane; γ-glycidoxypropyl methyldiethoxysilane; γ-glycidoxypropyldimethylethoxysilane; (γ-glycidoxypropyl)-bis-(trimethylsiloxy)methylsilane; vinylmethyldiethoxysilane; vinylmethyldimethoxy silane; methylaminopropyltrimethoxysilane; n-octyltriethoxysilane; n-octyltrimethoxy silane; hexyltriethoxysilane; isobutyltrimethoxy silane; 3-ureidopropyltriethoxysilane; 3-isocyanatepropyltriethoxysilane; N-phenyl-3-aminopropyltrimethoxysilane; 3-tri ethoxysilyl-N-(1,3-dimethyl-butyliden)propylamine; N-2(aminoethyl)-3-aminopropyltri ethoxysilane; triethoxysilane; N-2(aminoethyl)-3-aminopropyltrimethoxysilane; N-2-(aminoethyl)-3-aminopropylmethyldimethoxysilane; 3-acryloxypropyltrimethoxysilane; methacryloxypropylmethyldiethoxysilane; methacryloxypropylmethyldimethoxysilane; glycidoxypropylmethyldiethoxysilane; 2-(3,4-epoxycyclohexyl)-ethyltrimethoxysilane; vinyltriethoxysilane; amonophenyl trimethoxy silane; p-chloromethyl)phenyltri-n-propoxysilane; diphenylsilanediol; vinyltrimethoxy silane; 2-(3,4-epoxycyclohexyl) ethyltrimethoxysilane; epoxyhexyltriethoxysilane; tris(3-trimethoxysilylpropyl) isocyanurate; dococentyltrimethoxysilane; 3-mercaptopropyltriethoxysilane; 1,4-bis (trimethoxysilylethyl)benzene; phenylsilane; trimethoxy silyl-1,3-dithiane; n-trimethoxy silylpropylcarbamoylcaprolactam; 2-(diphenylphosphine)ethyltriethoxysilane; 3-cyano propyltrimethoxysilane; diethylphosphateethyltriethoxysilane; tetra-n-propoxide (Ti(OPr)₄); phenyltrimethoxysilane (PhTMOS); aminopropyltriethoxysilane (APTEOS); tetramethoxysilane (TMOS) and tetraethoxysilane (TEOS).

In some embodiments, the silica precursor is tetraethoxysilane (TEOS).

In some embodiments, the oil phase comprises TEOS and decane in an amount ranging between 10 and 30% w/w of the total weight of the emulsion.

The nanoemulsion is stabilized by at least one surfactant, making the oil droplets stable within the aqueous continuous phase. The at least one surfactant is a compound having an amphiphilic structure which endows the compound with an affinity for the oil/water or water/oil interfaces, enabling reduction in the free energy of the interface and stabilization of the dispersed system. The at least one surfactant is also selected to enable inversion of the emulsion, as disclosed herein.

In some embodiments, said at least one surfactant is an alkoxylated material comprising, in some embodiments, at least one chain of between 2 and 500 ethylene oxide or propylene oxide units, e.g., PEO and PEG. Non-limiting examples of said at least one surfactant include polyethylene glycol/phosphatidylethanolamine (PEG-PE); fatty acid and polyethylene glycol ethers, such as the products commercially available under the Brij® trade names, e.g., Brij® 30, 35, 58, 78, 96V or 98 (by ICI Americas Inc.,); fatty acid and polyethylene glycol esters, such as the products commercially available under the Myrj® trade names, e.g., Myrj® 45, 52, 53 or 59 (by ICI Americas Inc.,); ethylene oxide and propylene oxide block copolymers, such as the products commercially available under the Pluronic® trade name, e.g., Pluronic® F68, F127, L64, L61, 10R4, 17R2, 17R4, 25R2 or 25R4 (by BASF AG); and the products commercially available under the Synperonic® trade names, e.g., Synperonic® PE/F68, PE/L61 or PE/L64 (by Unichema Chemie BV).

In some embodiments, said at least one surfactant is selected from Brij® 30, Brij® 35, Brij® 58, Brij® 78, Brij® 96V and Brij® 98. In other embodiments, said at least one surfactant is selected from Brij® 30 and Brij® 96V.

In some embodiments, the O/W emulsion comprises water, TEOS, an hydrophobic material, and Brij® 30 and/or Brij® 96V.

In some embodiments, the at least one surfactant constitutes at least about 1% w/w of the total weight of the emulsion. In other embodiments, the at least one surfactant constitutes at most about 10% w/w of the total weight of the emulsion. In further embodiments, the emulsion comprises between 1 and 10% w/w surfactant, or between 2 and 7% w/w surfactant.

In some embodiments, the at least one surfactant is two or more surfactants, each being as defined herein. In some embodiments where two or more surfactants are employed, one surfactant is introduced prior to or after the emulsion inversion, namely prior to or after the PIT temperature is reached, endowing the emulsion with at least one additional property, such as positive or negative charges. A further surfactant may be employed to enable the inversion of emulsion.

In some embodiments, one or more of the at least two surfactants may be selected amongst ionic (anionic, cationic), nonionic, zwitterionic, amphoteric surfactants, soap, and combinations thereof.

In some embodiments, the surfactant is selected amongst ionic surfactants such as sodium dodecylsulfate (SDS), potassium dodecylsulfate, magnesium laurylsulfate, Polysorbate 20, Polysorbate 80, 1,2-dioleoyl-sn-glycero-3-ethylphosphocholinetriflate (EDOPC), sodium octadecylsulfate, sodium bis(2-ethylhexyl)sulfosuccinate (AOT), alkyl phosphocholine trimesters, didodecyl dimethyl ammonium bromide (DDAB), cetyl-triammonium bromide (CTAB), cetylpyridinium bromide (CPB), dodecyl trimethyl ammonium chloride (DOTAC), sodium perfluorononanoate (SPFN) and hexadecyl trimethyl ammonium bromide (HDTMA). In some embodiments, one or more of the at least two surfactants is selected from SDS and CTAB.

Other suitable surfactants are described in McCutcheon's, Detergents and Emulsifiers, North American edition (1986), published by allured Publishing Corporation; and McCutcheon's, Functional Materials, North American Edition (1992).

Interfacial polymerization, namely hydrolysis and polycondensation, of the silica precursor present in the nanoemulsion may be induced at any stage of the process of the invention, but preferably after the nanoemulsion is formed, at a temperature below the PIT temperature, by the addition of a catalyst such as an acid or a base. Typically, the polymerization is induced by the addition of a catalytic amount of an acid, e.g., HCl and/or a base, e.g., ammonia. In some embodiments, prior to the addition of the catalyst, the nanoemulsion is diluted, e.g., with water, in order to prevent aggregation.

In other embodiments, the hydrolysis and polycondensation of the silica precursor, e.g., TEOS, which leads to the formation of the nanocapsule shell, is carried out at room temperature (23-27° C.). In further embodiments, the reaction is carried out under continuous stirring, e.g., 100-1500 RPM, over a period of time sufficient to afford a maximum encapsulation, e.g., over a period of a few hours, or 12 hours, or 18 hours, or 24 hours or more than 24 hours.

The nanocapsules obtained according to the process of the invention are core-shell structures having a silica shell and a hydrophobic core. On average, the nanocapsules obtained have diameters between a few nanometers and 1000 nanometers. In some embodiments, the nanocapsules are 50 to 1000 nm in diameter. In other embodiments, the nanocapsules are 50 to 900 nm in diameter. In further embodiments, the nanocapsules are 50 to 200 nm in diameter.

The nanocapsules may be used for a variety of applications and based on the specific intended application, the oil phase may be selected and parameters of the process accordingly adjusted. For example, the nanocapsules may be used for the protection, transmission and controlled releasing of active ingredients, e.g., drugs, proteins, vitamins, flavors, coloring agents, antioxidants, etc., for the improvement of long-term efficiency, for the stabilization of a material against degradation, e.g., environmental degradation, for preventing it from contact with other components of the formulation, for the easy handling of a material, for the long term or sustained release of a material, for the maintenance of non-toxicity of a material, etc.

Thus, in another aspect of the invention, there is provided a nanocapsules or a plurality thereof manufactured according to the process of the invention as disclosed herein.

Also provided are suspensions of nanocapsules obtained according to the invention.

The invention also encompasses various uses of the nanocapsules prepared and various formulations/composition comprising them.

As used herein, the process of the invention may include additional steps or ingredients or parts, only if the additional steps, ingredients, or parts do not alter the basic and novel characteristics of the claimed process. As used herein, the singular form “a”, “an” and “the” include plural references unless the context clearly dictates otherwise. Equivalently, the plural reference to “nanocapsules” similarly includes reference to single nanocapsules.

It should be noted that where various embodiments are described by using a given range, the range is given as such merely for convenience and brevity and should not be construed as an inflexible limitation on the scope of the invention. Accordingly, the description of a range should be considered to have specifically disclosed all the possible sub-ranges as well as individual numerical values within that range.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 presents the chemical structure of Brij 96 and Brij 30.

FIG. 2 demonstrates the conductivity as a function of temperature in an emulsion containing 6% (w/w) TEOS (30% TEOS in the oil phase), 16% (w/w) decane and 4% (w/w) Brij 96V. The aqueous phase is 10 mM NaCl.

FIG. 3 demonstrates the phase inversion temperatures (PIT) as a function of surfactant type and concentration. Emulsions prepared using Brij 30 and Brij 96V in concentration ranging from 2% (w/w) to 7% (w/w). Emulsions contained 4% (w/w) TEOS and 16% (w/w) decane.

FIGS. 4A-B present the droplet and capsules sizes as a function of surfactant and catalyst type. FIG. 4A—Emulsions prepared using between 2% (w/w) to 5% (w/w) Brij 30; and FIG. 4B—Emulsions prepared using between 3% (w/w) to 7% (w/w) Brij 96V. The catalysts were HCl and Ammonia.

FIGS. 5A-D are FTIR spectra of: FIG. 5A—TEOS; FIG. 5B—Nanocapsules dispersion after polymerization under basic conditions; FIG. 5C—Nanocapsules dispersion after polymerization under acidic conditions; and FIG. 5D—ethanol. The nanocapsules contained: 4% (w/w) TEOS, 16% (w/w) decane and 4% (w/w) Brij 96V.

FIGS. 6A-C are HR-SEM images—FIG. 6A and FIG. 6B—and DLS measurements FIG. 6C of silica nanocapsules prepared under acidic conditions. The nano-emulsion contained a solution of 20% (w/w) TEOS in decane as the oil phase (20% (w/w) oil phase) and 4% (w/w) Brij 96V as the surfactant.

FIGS. 7A-C are HR-SEM images—FIG. 7A and FIG. 7B—and DLS measurements FIG. 7C of silica nanocapsules prepared under acidic conditions. The nano-emulsion contained a solution of 20% (w/w) TEOS in decane as the oil phase (20% (w/w) oil phase) and 4% (w/w) Brij 96V as the surfactant.

### DETAILED DESCRIPTION OF EMBODIMENTS

The present application discloses a process for the preparation of silica nanocapsules, by interfacial polymerization (hydrolysis and polycondensation) of nano-emulsions, prepared by the phase inversion temperature method. This is a low-energy emulsification technique which does not require any special equipment such as high pressure homogenizers. The nanoemulsions have been prepared using decane as an exemplary oil phase, in which tetraethoxysilane (tetra orthosilicate or TEOS) was dissolved and in the presence of Brij 30 or Brij 96V as surfactant materials. The polymerization of the TEOS was achieved under acidic or basic conditions using HCl or ammonia, respectively. The obtained nanocapsules comprised of an oily core (decane) and a silica shell were characterized using dynamic light scattering, FTIR, HR-SEM and fluorescence by encapsulation of Nile Red (a solvatochromic dye).

Various embodiments and aspects of the present invention as delineated hereinabove and as claimed in the claims section below find experimental support in the following examples. As may be understood, the embodiments described are merely examples of the process of the invention and should not be considered limiting.

### Preparation of the Nanoemulsions

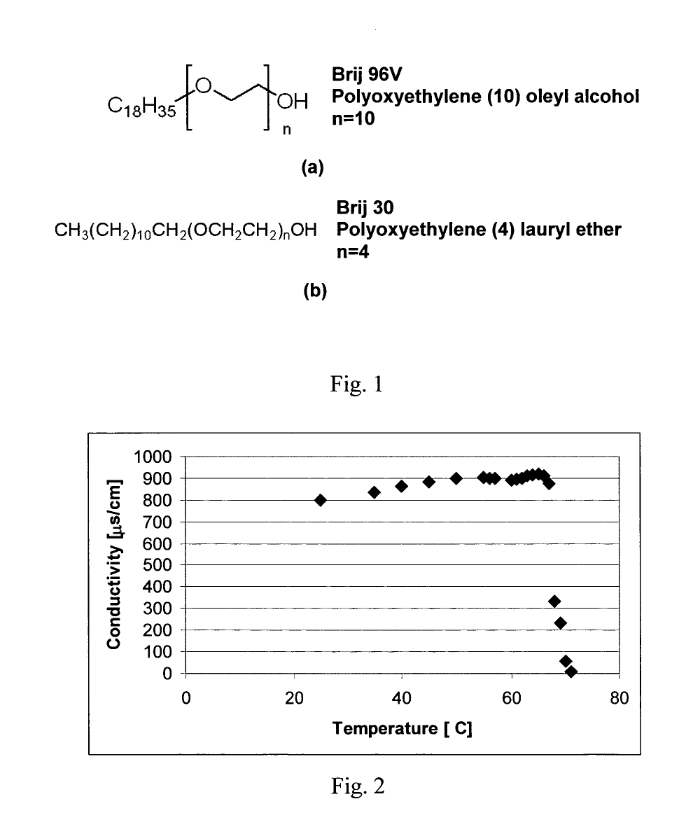

Crude O/W emulsions were prepared by using a magnetic stirrer at 750 RPM for 10 minutes. The emulsions contained 20% (w/w) oil phase (a solution of TEOS in decane) and between 2% (w/w) to 7% (w/w) surfactant (Brij 30 or Brij 96V). The chemical structures of the surfactants employed are presented in FIG. 1.

Unless otherwise stated, the concentrations of the components are related to the entire volume of the emulsion. NaCl (10 mM) was used as the aqueous phase. The crude O/W emulsions were heated above the PIT temperature at which W/O emulsions are obtained and then rapidly cooled in an ice bath, resulting in O/W nanoemulsions.

### Determination of the Phase Inversion Temperature

The PIT temperature was determined by measuring the conductivity of the emulsions during the heating process. Since 10 mM NaCl was used as the aqueous phase, the conductivity increased with heating until it reached the PIT temperature at which temperature it dropped to zero. At this temperature, the oil phase became the continuous phase and the emulsion inverted. The PIT was taken as the average value of the temperature at which the conductivity is the highest and the lowest. The conductivity was measured using the Oyster Conductivity/Temperature meter (Extech Instruments).

### Preparation of the Nanocapsules

TEOS was dissolved in the oil phase (decane) prior to nanoemulsion preparation. The nanoemulsions were diluted 10 times before polymerization in order to prevent aggregation. The polymerization reaction (hydrolysis and polycondensation of TEOS) was carried out under two alternative conditions: acidic (using HCl as the catalyst) or basic (using ammonia as the catalyst), over a period of 24 hours at room temperature and under continuous stirring (750 RPM).

When Nile Red was encapsulated in the core of the nanocapsules, as an exemplary hydrophobic material for encapsulation, it was dissolved in decane prior to nanoemulsion preparation. When the charged nanocapsules were prepared the ionic surfactants (SDS or CTAB) were added after the dilution of the emulsions and before polymerization.

### Droplet and Particle Size Measurements

The size distributions of the nanodroplets or the nanocapsules were obtained by photon correlation spectroscopy (PCS) using Nano ZS (Malvern Instruments, Malvern, UK). A few drops of each sample were added to 4 ml filtered distilled water (0.2 μm PVDF filter Millipore) in a polystyrene disposable cuvette. The average size by volume distribution was reported for each measurement.

### FTIR Measurements

Samples were analyzed using ATR-FTIR (Alfa (Bruker)). The decay of the typical TEOS IR bands at 466 cm⁻¹ (δₐₛ(SiOC)) and 1099 cm⁻¹ (νₐₛ(SiOC)) and the appearance of the IR band at 1045 cm⁻¹, ascribed to ethanol, was followed as an indication of the polymerization reaction.

### HR-SEM Imaging

Samples were viewed using HR-SEM-Sirion (FEI). Excess surfactant was washed with hot water at 40° C. and removed by centrifugation, three times. The samples were placed on an Aluminum SEM stab and left to dry. The dried samples were spattered with gold before HR-SEM imaging.

### Zeta Potential Measurements

The zeta potential was measured using Nano ZS (Malvern Instruments, Malvern, UK), employing a zeta potential capillary cell equipped with integral gold electrodes. The zeta potential was calculated by measuring the electrophoretic mobility, using the Smoluchowsky approximation [21]:

UE=εζ/η

where ζ is the zeta potential, UE is the electrophoretic mobility, ε is the dielectric constant and η is the viscosity [22].

Samples were diluted with an aqueous solution of 10 mM NaCl prior to measurement. The zeta potential was taken as an average of three measurements.

### Fluorescence Measurements

Fluorescence spectra of the samples containing Nile Red were collected using a Cary Eclipse (Varian) spectrofluorophotometer (at a scan rate of 600 nm/min). Excitation and emission slits were both fixed at 5 nm, and λₑₓ was 500 nm. Excess of surfactant was removed by washing with hot water at 40° C. and centrifugation, before spectrum collection.

### Results

### Decane-TEOS Nanoemulsions

Crude O/W emulsions containing 20% (w/w) oil phase (between 10-60% w/w TEOS dissolved in decane) and between 2% (w/w) to 7% (w/w) surfactant (Brij 96V (HLB-12.4) or Brij 30 (HLB-9.7)) were prepared. The PIT temperatures of these emulsions were determined by following the conductivity of the emulsions during heating, as described hereinabove. A typical conductivity profile of an emulsion prepared of 4% (w/w) Brij 96V and 6% (w/w) TEOS (30% w/w in the oil phase) is presented in FIG. 2. As shown, the conductivity of the emulsion initially increased, reaching a maximum, and then suddenly decreased. The initial increase in the conductivity of the emulsions was ascribed to a higher mobility of ions in the system at the high temperature. A sharp drop in the conductivity occurred when the oil phase became a continuous phase. This kind of conductivity profile was reported also by Izquierdo et al. [17] and Anton et al. [22] dealing with emulsions prepared by the PIT method.

It was found that the point of zero conductivity of emulsions according to the invention changed only slightly (e.g., between 70° C.-71° C.) when the concentration of TEOS was increased from 10% (w/w) to 60% (w/w) in the oil phase, although the temperature at which the conductivity began decreasing varied from 54° C., at 10% TEOS, to 59° C., at 60% TEOS, while using 4% Brij 96V as the surfactant.

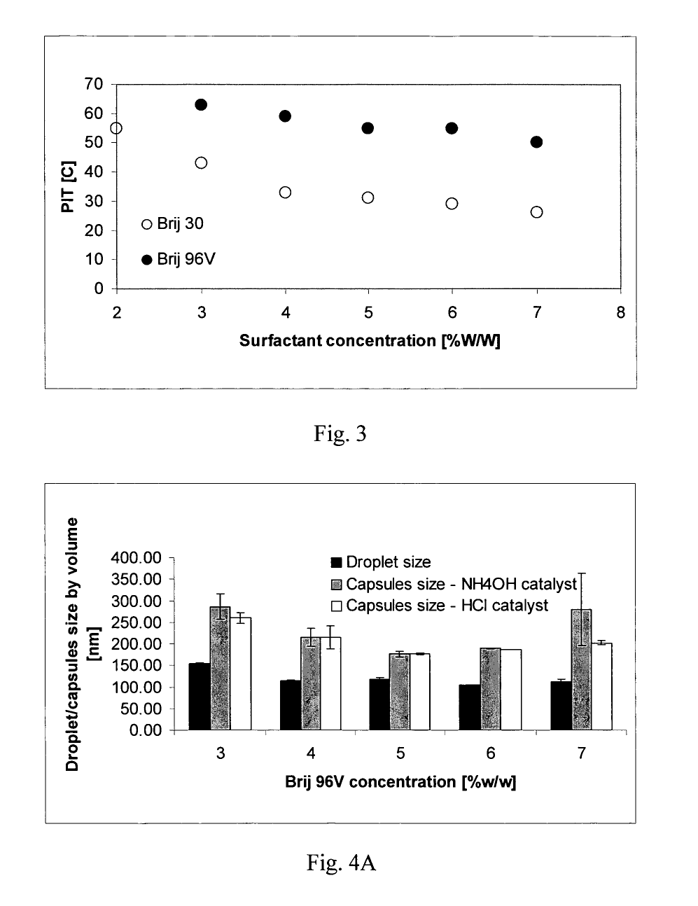

The PIT temperatures of the emulsions prepared using Brij 96V (HLB-12.4) and Brij 30 (HLB-9.7), at various surfactant concentrations, are presented in FIG. 3. It was found that the PIT temperature decreased as the surfactant concentration increased. In addition, a decrease in the HLB of the surfactant caused a decrease in the PIT temperature, for a given surfactant concentration, as demonstrated for Brij 30 (HLB-9.7) and Brij 96V (HLB-12.4). The decrease in the PIT temperature was more pronounced as the surfactant concentration increased. These results are in agreement with previously reported results by Izquierdo et al. [17], Forster et al. [18] and Kunieda and Shinoda [23], who found similar trends in the PIT temperatures of emulsions containing oils such as isooctane, isohexadecane, cyclohexane, ethylbenzene, dodecylbenzene and n-alkanes.

### Silica Nanocapsules

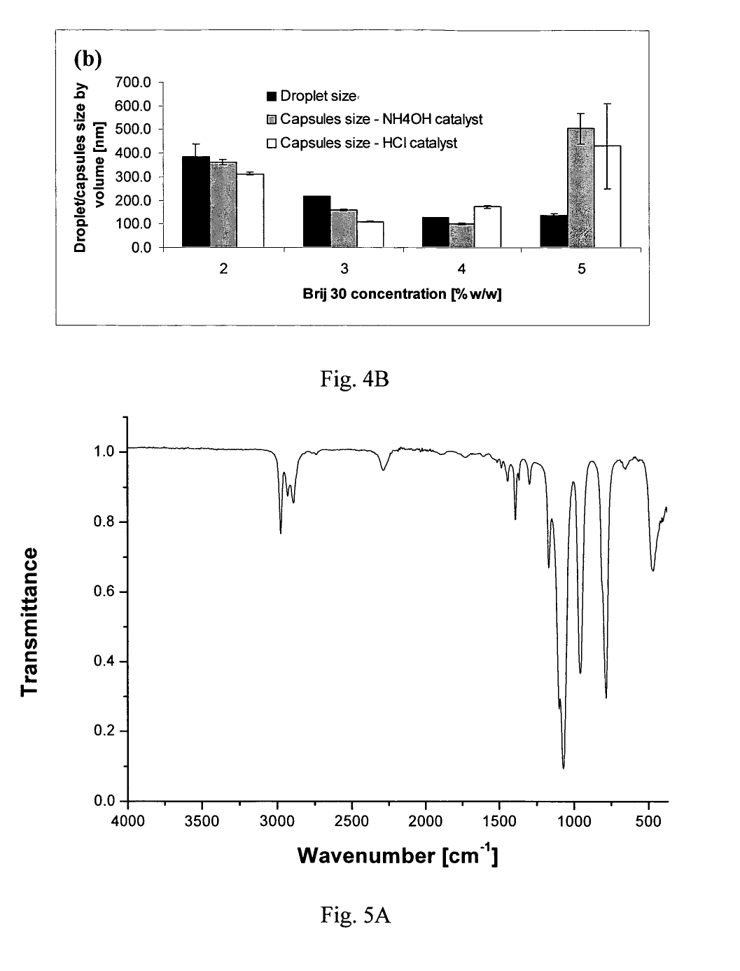

Hydrolysis and polycondensation of TEOS in the O/W nano-emulsion was achieved under acidic or basic conditions, using solutions of 3.5% (w/w) HCl and 10% (w/w) NH₄OH, adjusted to pH 2-3 or 9-10, respectively, as described hereinabove. Droplet and capsules sizes prepared using Brij 96V and Brij 30 are presented in FIGS. 4a and 4b, respectively. It can be observed that the capsules sizes, in some cases, were higher than the corresponding droplet sizes. This can be explained by aggregation of the capsules occurring during the polymerization reaction, and which could not have been prevented by the dilution of the nanoemulsions before polymerization.

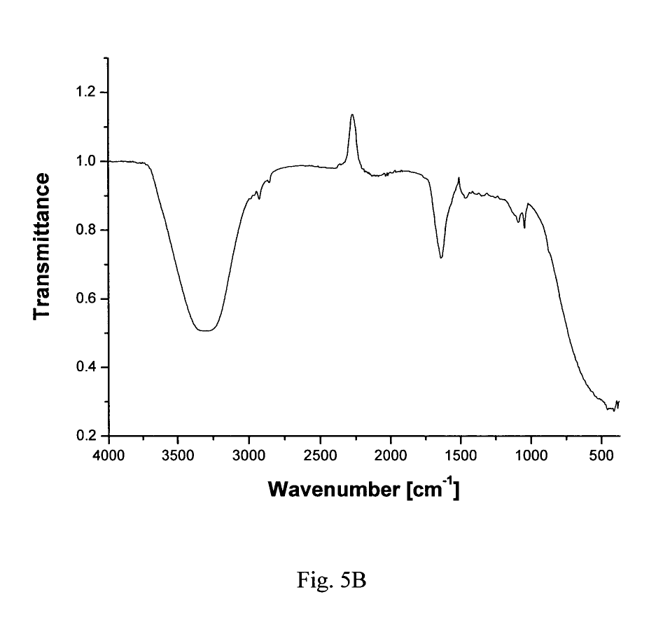

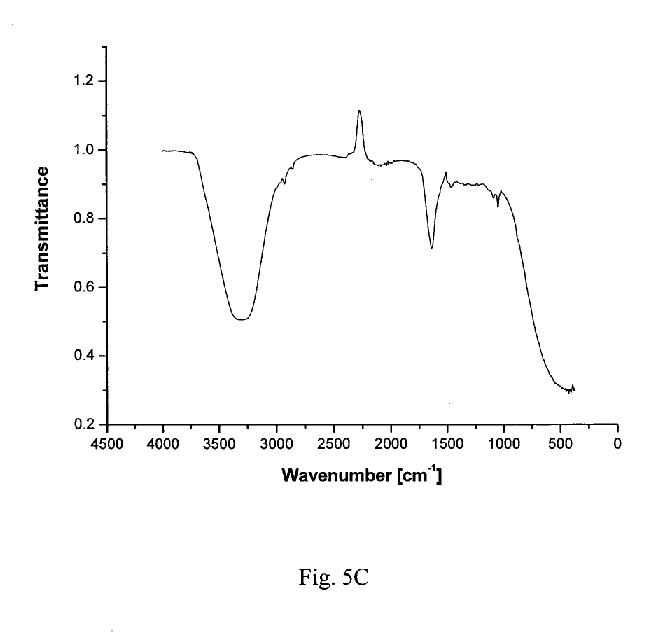

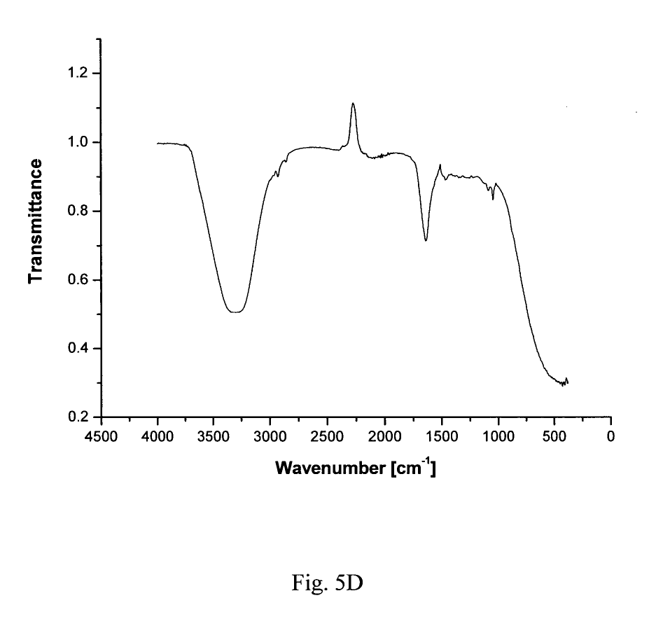

The interfacial polymerization reaction was followed by FTIR measurements, exhibiting the disappearance of the typical IR bands of TEOS and the appearance of the peak ascribed to ethanol, which is formed during the reaction. FIG. 5 presents the FTIR spectra of TEOS (FIG. 5a) and the dispersion of the nanocapsules, after polymerization, under basic and acidic conditions (FIG. 5b and FIG. 5c, respectively). The TEOS spectra showed IR bands at 466 cm⁻¹ (δₐₛ(SiOC)) and 1099 cm⁻¹ (νₐₛ(SiOC)), as previously had been described in the literature [7, 24]. These IR bands disappeared after polymerization and a peak at 1045 cm⁻¹, which was ascribed to the C—C—O stretching of ethanol, appeared [25]. The FTIR spectrum of ethanol is presented in FIG. 5d, as reference.

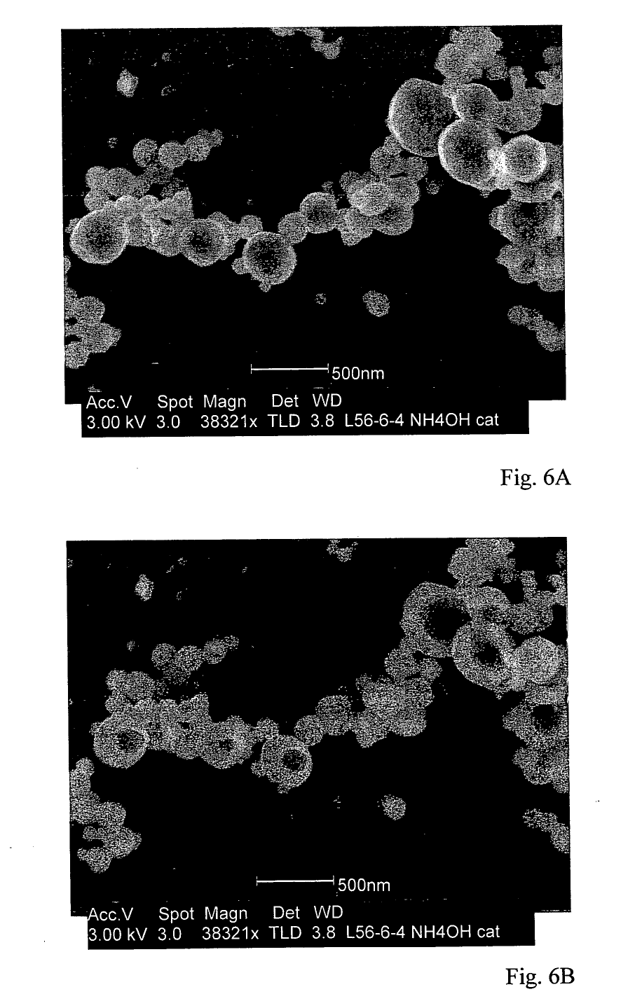

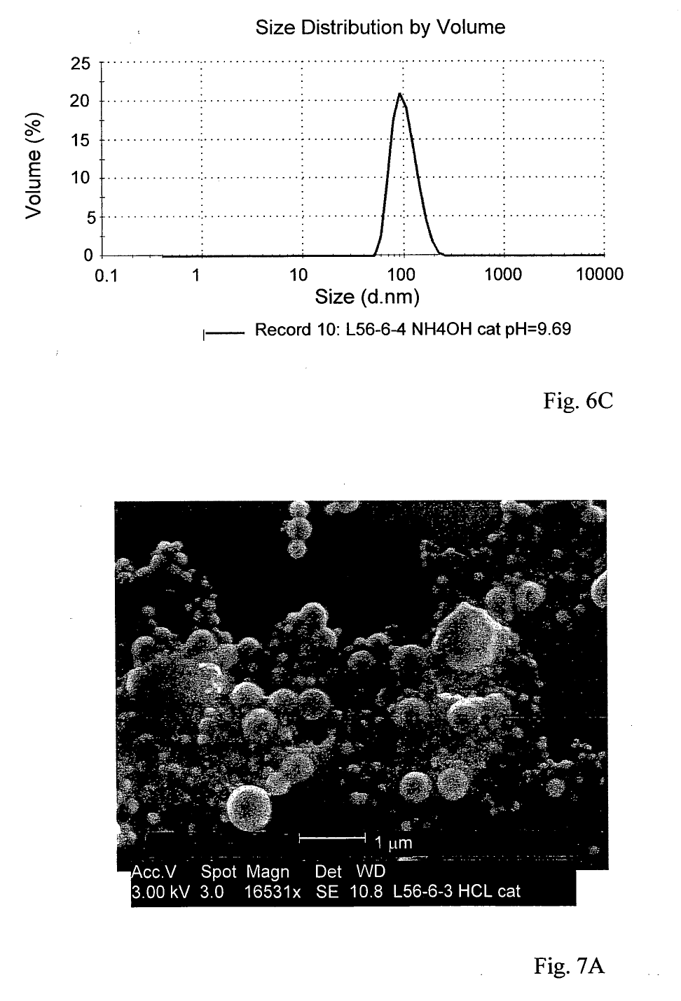

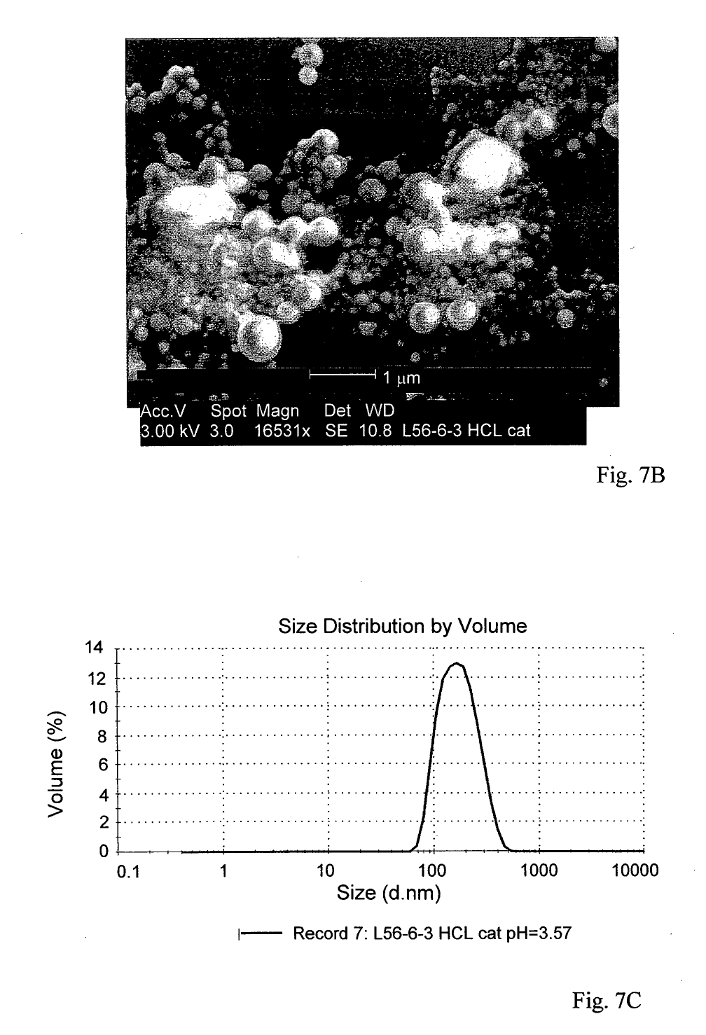

FIG. 6 and FIG. 7 present HR-SEM images and the corresponding DLS measurements of the nanocapsules prepared under basic and acidic conditions, respectively. It may be noted that there is a correlation between the measured capsules sizes and the capsules observed by the HR-SEM. In addition, the holes in the capsules are clearly seen in FIG. 5b (capsules prepared under basic conditions). These holes are the result of an interaction of the nanocapsules with the electron beam.

In order to demonstrate the ability of these nanocapsules to encapsulate hydrophobic materials, the encapsulation process was performed, as described above. Table 1 presents the emission peaks of Nile Red in decane, TEOS, micellar solution of Brij 96V, a nanoemulsion after inversion and nanocapsules. The nanoemulsion and the nanocapsule samples showed a weak shoulder band at 527 nm, which could be ascribed to the decane environment.

TABLE 1
Emission peaks of Nile Red in different media. Nile red
concentration used: 10⁻⁵ M.

| Medium | Emission peaks [nm] |
|---|---|
| Decane | 532, 569 |
| TEOS | 569 |
| 4% (w/w) Brij 96V aqueous | 632 |
| solution | |
| Nano-emulsion after inversion^{a} | 527^{b} |
| Nanocapsules^{a} | 527^{b} |

^{a}The nanoemulsion and nanocapsules were prepared using: 4% (w/w) Brij 96V and 20% (w/w) oil phase (20% TEOS in Decane). 10 mM NaCl was used as the aqueous phase.
^{b}A weak shoulder band.

The capsules were also stabilized by ionic surfactants to obtain charged nanocapsules, as described herein. 0.3% (w/w) SDS or 0.3% CTAB (based on the total weight of the sample) was added to the diluted nanoemulsions after inversion and were then polymerized under acidic or basic conditions. The Zeta potential measurements are presented in Table 2. The Zeta potential measurements showed that a negative charge or a positive charge could be applied to the nanocapsules, upon addition of SDS or CTAB, respectively.

TABLE 2
Zeta potential measurements of charged nanocapsules. The charged
nanocapsules were obtained by addition of 0.3% (w/w) SDS and
0.3% (w/w) CTAB (based on the total weight of the diluted sample).

| | Catalyst | | Stabilizer | Zeta Potential |
|---|---|---|---|---|
| Sample No. | [% w/w] | pH | [% w/w] | [mV] |
| 1 | 3.5% HCl | 2.35 | 0.3% CTAB | 38.2 ± 1.8 |
| 2 | 3.5% HCl | 2.39 | — | −2.8 ± 1.1 |
| 3 | 3.5% HCl | 2.41 | 0.3% SDS | −36.5 ± 1.9 |
| 4 | 10% NH₄OH | 10.26 | 0.3% CTAB | 40.25 ± 1.3 |
| 5 | 10% NH₄OH | 10.24 | — | −8.275 ± 0.1 |
| 6 | 10% NH₄OH | 10.47 | 0.3% SDS | −33.9 ± 0.4 |

1-41. (canceled)

42. A process for the manufacture of silica nanocapsules, said process comprising:
obtaining a nanoemulsion of an aqueous phase and an oil phase and at least one surfactant, the nanoemulsion being formed by the process comprising:
(i) forming an oil-in-water (O/W) emulsion of an aqueous phase and an oil phase comprising at least one hydrophobic material and at least one silica precursor in the presence of at least one surfactant,
(ii) heating the O/W emulsion above its phase inversion temperature (PIT) to obtain a water-in-oil (W/O) emulsion, and
(iii) cooling the W/O emulsion below the PIT temperature, thereby forming a nanoemulsion of oil droplets in water;
inducing interfacial polymerization of the silica precursor around the oil droplets in the nanoemulsions thereby obtaining said silica nanocapsules.

43. The process according to claim 42, wherein steps (ii) and (iii) are repeated one or more times.

44. The process according to claim 42, wherein the aqueous phase comprises a salt.

45. The process according to claim 42, wherein the W/O emulsion is cooled to a temperature below room temperature (23-27° C.).

46. The process according to claim 42, wherein the at least one hydrophobic material is a liquid material, being selected from a pure hydrophobic liquid, a mixture of hydrophobic liquids and a liquid solution composed of a liquid carrier solubilizing at least one hydrophobic material.

47. The process according to claim 42, wherein the at least one hydrophobic material is selected from a wax, a fatty alcohol, a fatty acid, naturally occurring waxes, an oil, a hydrocarbon, a silicone oil, a mineral oil, a fluorocarbon oil, an organic solvent, an animal oil, a vegetable oil, a natural oil, a synthetic oil, a semi-synthetic oil.

48. The process according to claim 42, wherein said at least one hydrophobic material is selected from a drug, a bioactive, a cosmetic material, a flavoring agent, a coloring agent and an antioxidant.

49. The process according to claim 42, wherein said hydrophobic material is retinol or a derivative thereof.

50. The process according to claim 42, wherein the oil phase constitutes at least 10% w/w of the total weight of the emulsion of (i).

51. The process according to claim 42, wherein the oil phase constitutes at least 10% w/w of the total weight of the emulsion of (i).

52. The process according to claim 42, wherein said at least one silica precursor is at least one water-insoluble organosilane.

53. The process according to claim 42, wherein the oil phase comprises TEOS and at least one hydrophobic material in an amount ranging between 10 and 30% w/w of the total weight of the emulsion.

54. The process according to claim 42, wherein said at least one surfactant is an alkoxylated material.

55. The process according to claim 42, wherein said at least one surfactant constitutes at least about 1% w/w of the total weight of the emulsion.

56. The process according to claim 42, wherein said at least one surfactant constitutes at most about 10% w/w of the total weight of the emulsion.

57. The process according to claim 42, wherein the O/W emulsion comprises water, TEOS, an hydrophobic material, and Brij® 30 and/or Brij® 96V.

58. The process according to claim 42, wherein interfacial polymerization of the silica precursor present in the nanoemulsion is induced by the addition of a catalyst.

59. The process according to claim 42, further comprising the dilution of the nanoemulsion prior to interfacial polymerization.

60. The process according to claim 42, wherein the interfacial polymerization is carried out at a temperature below the PIT temperature.

61. The process according to claim 42, wherein the average size of the nanocapsules is at most 1 micron.
